(19) United States
(12) Patent Application Publication
(10) Pub. No.: US 2025/0340126 A1
(43) Pub. Date: Nov. 6, 2025

(54) IMPLEMENTING A TORQUE FUSE IN AN ELECTRIC MARINE PROPULSION SYSTEM

(71) Applicant: VISION MARINE TECHNOLOGIES, BOISBRIAND (CA)

(72) Inventor: XAVIER MONTAGNE, LAVAL (CA)

(21) Appl. No.: 18/656,061

(22) Filed: May 6, 2024

(51) Int. Cl. B60L 15/20; B63H 21/17

(52) U.S. Cl. CPC B60L 15/20; B63H 21/17; B60L 2200/32; B60L 2240/421; B60L 2240/423; B60L 2240/52

(57) ABSTRACT

Various embodiments for implementing a torque fuse in an electric marine propulsion system are described herein. In some aspects, a power control unit directs an inverter to supply power to an electric motor of an electric marine propulsion system for a watercraft. The power control unit also receives sensor data indicating a rotational speed of the electric motor and receives a torque value for the electric motor. In this embodiment, the power control unit also determines whether the rotational speed of the electric motor is at or below a first threshold and the torque value is at or above a second threshold. In response to determining that the rotational speed of the electric motor is at or below the first threshold and the torque value is at or above the second threshold, the power control unit directs the inverter to not supply the power to the electric motor.

### FIELD OF THE TECHNOLOGY

The present disclosure relates to methods, apparatuses, and computer program products for implementing a torque fuse in an electric marine propulsion system.

### BACKGROUND

Advances in battery technology have paved the way for full-electric vehicles. Building on those advances, technology to enable full-electric watercraft has been widely adopted. However, the challenges of designing electric vehicles are different from the challenges of designing electric boats. The transformation of existing watercraft platforms to a full-electric platform also poses a different set of challenges.

### SUMMARY

According to embodiments of the present disclosure, various methods, apparatuses, and computer program products for implementing a torque fuse in an electric marine propulsion system are described herein. In some aspects, a power control unit directs an inverter to supply power to an electric motor of an electric marine propulsion system for a watercraft. The power control unit also receives sensor data indicating a rotational speed of the electric motor and receives a torque value for the electric motor. In this embodiment, the power control unit also determines whether the rotational speed of the electric motor is at or below a first threshold and the torque value is at or above a second threshold. In response to determining that the rotational speed of the electric motor is at or below the first threshold and the torque value is at or above the second threshold, the power control unit directs the inverter to not supply the power to the electric motor.

It will therefore be appreciated that a power control unit that shuts down the supply of power to an electric motor in response to detecting the speed of the electric motor being at or below a first threshold while the torque from the electric motor is at or above a second threshold enhances the function and safety of the marine propulsion system by protecting the electric motor in the event the propeller of the marine propulsion system becomes stuck or obstructed.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a block diagram of an example vessel that implements a torque fuse in an electric marine propulsion system in accordance with at least one embodiment of the present disclosure.

FIG. 1B sets forth a block diagram of an example marine propulsion system that implements a torque fuse in accordance with at least one embodiment of the present disclosure.

FIG. 1C sets forth a block diagram of an example high voltage battery for implementing a torque fuse in an electric marine propulsion system in accordance with at least one embodiment of the present disclosure.

FIG. 1D sets forth a block diagram of an example power distribution unit for implementing a torque fuse in an electric marine propulsion system in accordance with at least one embodiment of the present disclosure.

FIG. 1E sets forth a block diagram of an example vessel control unit for implementing a torque fuse in an electric marine propulsion system in accordance with at least one embodiment of the present disclosure.

FIG. 2 sets forth a block diagram of an example electric marine propulsion system that implements a torque fuse in accordance with at least one embodiment of the present disclosure.

FIG. 3 sets forth a flow chart of an example method for implementing a torque fuse in an electric marine propulsion system in accordance with at least one embodiment of the present disclosure.

FIG. 4 sets forth a flow chart of another example method for implementing a torque fuse in an electric marine propulsion system in accordance with at least one embodiment of the present disclosure.

FIG. 5 sets forth a flow chart of another example method for implementing a torque fuse in an electric marine propulsion system in accordance with at least one embodiment of the present disclosure.

FIG. 6 sets forth a flow chart of another example method for implementing a torque fuse in an electric marine propulsion system in accordance with at least one embodiment of the present disclosure.

FIG. 7 sets forth a flow chart of another example method for implementing a torque fuse in an electric marine propulsion system in accordance with at least one embodiment of the present disclosure.

FIG. 8 sets forth a flow chart of another example method for implementing a torque fuse in an electric marine propulsion system in accordance with at least one embodiment of the present disclosure.

FIG. 9 sets forth a flow chart of another example method for implementing a torque fuse in an electric marine propulsion system in accordance with at least one embodiment of the present disclosure.

FIG. 10 sets forth a flow chart of another example method for implementing a torque fuse in an electric marine propulsion system in accordance with at least one embodiment of the present disclosure.

FIG. 11 sets forth a flow chart of another example method for implementing a torque fuse in an electric marine propulsion system in accordance with at least one embodiment of the present disclosure.

FIG. 12 sets forth a flow chart of another example method for implementing a torque fuse in an electric marine propulsion system in accordance with at least one embodiment of the present disclosure.

FIG. 13 sets forth a flow chart of another example method for implementing a torque fuse in an electric marine propulsion system in accordance with at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

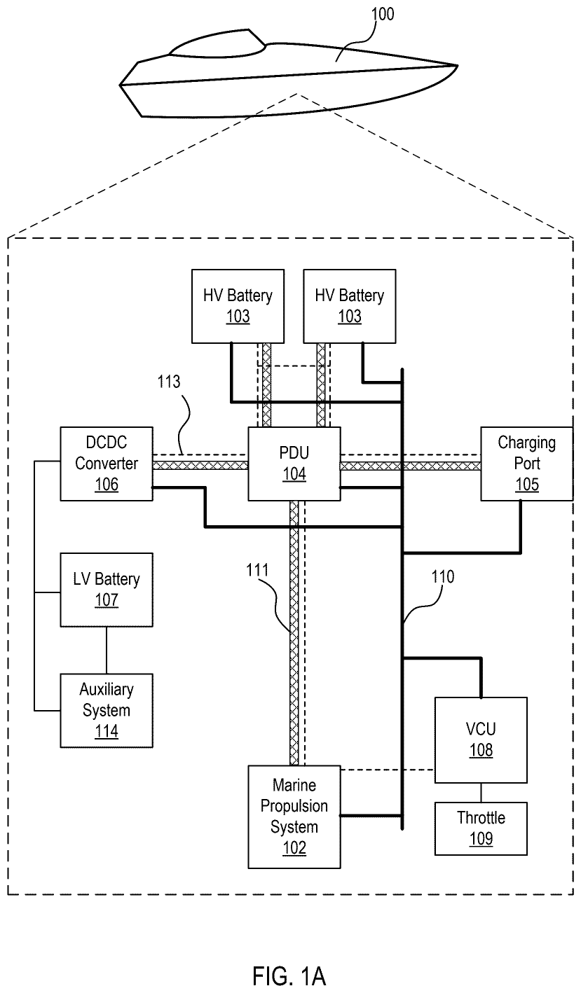

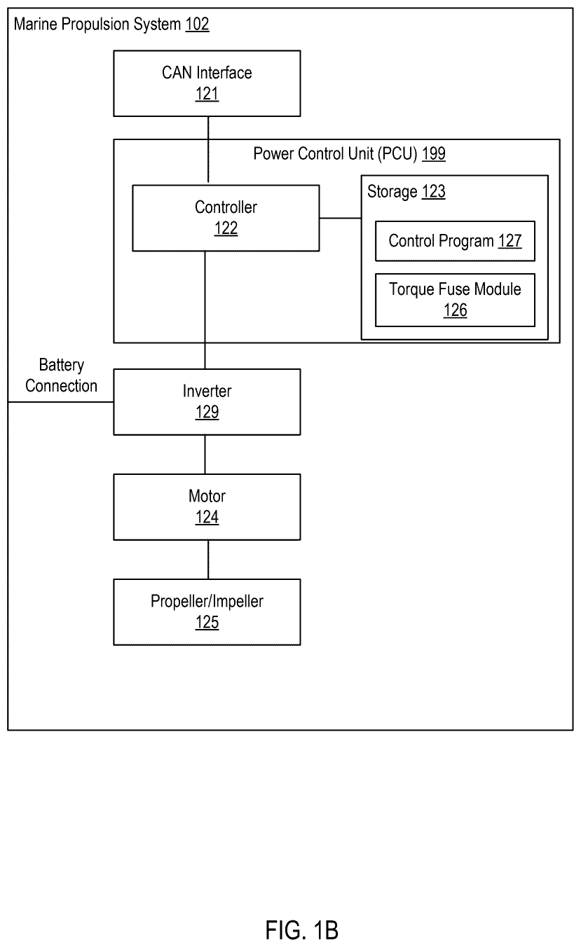

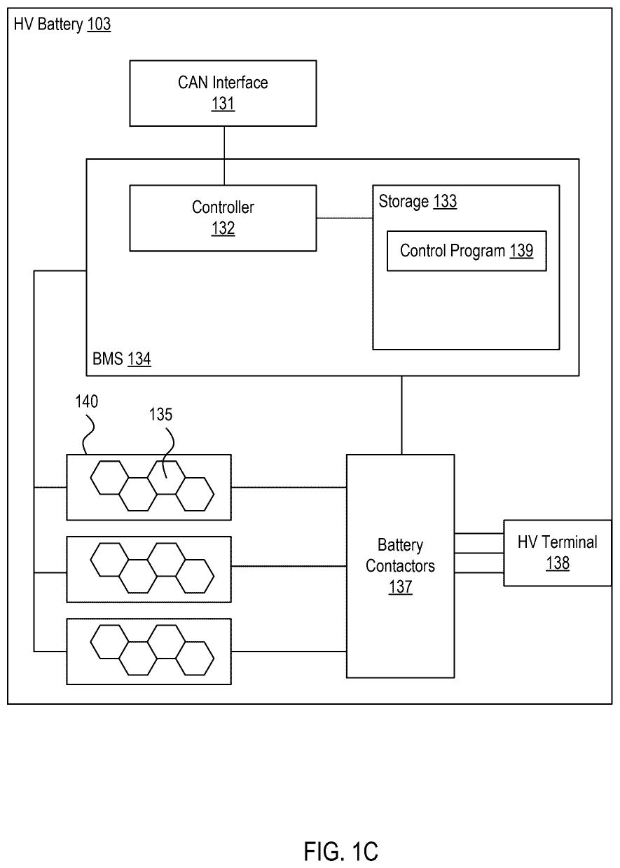

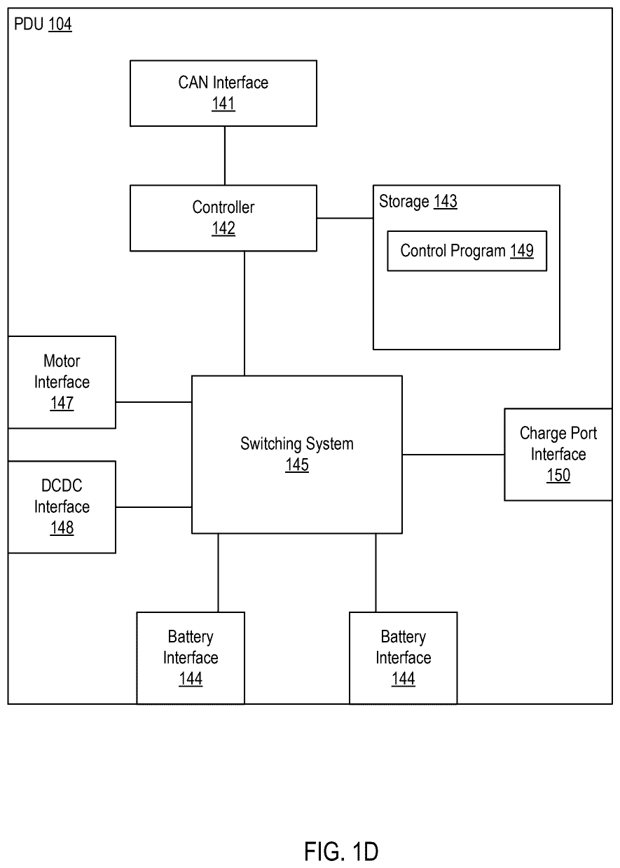

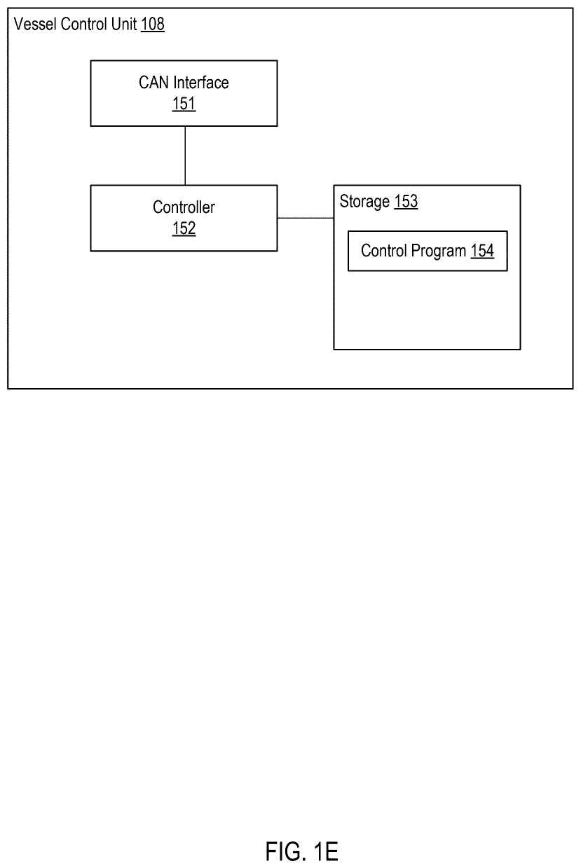

For further explanation, FIG. 1A sets forth an example electric vessel 100 that implements a torque fuse in an electric marine propulsion system in accordance with the present disclosure. FIG. 1A is provided to emphasize the powertrain components of vessel 100. It will be appreciated that vessel 100 may include other components not shown or described herein. Vessel 100 may be any type of watercraft. In a particular example, vessel 100 includes a full-electric powertrain and thus may also referred to as an ‘electric boat.’ To that end, vessel 100 includes a marine propulsion system 102. For example, marine propulsion system 102 may be a full-electric outboard motor or inboard motor with a propeller, or a full-electric jet craft with an impeller. The marine propulsion system is described in more detail below with reference to FIG. 1B.

The marine propulsion system 102 is powered by one or more high voltage batteries 103. In the example, of FIG. 1A, two high voltage batteries 103 are shown; however, it will be appreciated a vessel 100 in accordance with the present disclosure may include fewer or more high voltage batteries. High voltage batteries operate at voltages ranging from a few hundred to over 800 volts, depending on the design and application. Higher voltages allow for more efficient power transmission and reduced current flow, which helps minimize energy losses. Each high voltage battery 103 includes multiple modules, each containing several individual battery cells connected in series and parallel configurations to achieve the desired voltage and capacity. These cells may be arranged in a pack that optimizes space utilization and facilitates thermal management. Each high voltage battery 103 includes or is coupled to a battery management system (BMS). The BMS is responsible for monitoring and controlling various parameters such as voltage, current, temperature, and state of charge (SoC) of individual cells within the pack. The BMS helps optimize battery performance, protect against overcharging or over-discharging, and ensures safety. The BMS communicates with other vessel components about battery state, receives commands to change the battery state, and controls the opening and closing of the main contactors in the battery. The high voltage battery 103 is described in more detail below with reference to FIG. 1C.

The marine propulsion system 102 receives power from the high voltage battery 103 via a power distribution unit (PDU) 104. The PDU 104 receives high-voltage DC power from the high voltage batteries 103 and routes it to different subsystems and components within vessel 100, such as the electric marine propulsion system 102 and other subsystems such as a DCDC converter 106. The PDU 104 also couples the high voltage batteries 103 to a charging port 105 for charging the high voltage batteries 103. The PDU 104, as explained in more detail below with reference to FIG. 1D, includes a set of contactors that are controlled by logic or software in the PDU 104 to ensure safety when switching the flow of power among various vessel components.

The DCDC converter 106 provides voltage conversion capabilities to step down the high-voltage DC power to lower voltages required by an auxiliary system, such as the 12-volt electrical system used for lights, accessories, and onboard electronics. The DCDC converter 106 may be used to charge a lower voltage battery such as a 12-volt marine battery 107, which is used to power an auxiliary system 114, such as lights, audio equipment, and other 12-volt powered systems on the vessel 100.

Vessel 100 further includes a vessel control unit 108. Vessel control unit 108 serves as the central control unit responsible for managing and coordinating various functions and systems onboard the vessel 100. For example, the vessel control unit 108 can provide propulsion control, including regulating engine speed, torque, and direction to achieve desired propulsion performance and maneuverability in accordance with commands or signals received from the vessel's throttle control 109. The vessel control unit 108 can also manage the vessel's steering system. The vessel control unit 108 can also control startup/shut down routines, control charging/operation mode selection, control the opening and closing of contactors in the PDU 104, monitor the state of onboard systems, perform vessel diagnostics, and interface with an operator dashboard. To that end, the vessel control unit 108 may communicate with the other vessel powertrain components (e.g., the marine propulsion system 102, the high voltage battery 103, the PDU 104, the DCDC converter 106, and so one) via a control area network (CAN), referred to herein as a CAN bus 110. The vessel control unit 108 will be described in more detail below with reference to FIG. 1E.

The CAN bus 110 may be a two-wire serial bus that allows multiple components and devices within a vessel to communicate with each other without a host computer. The CAN bus 110 may use a message-based communication scheme where components and devices send and receive data in the form of messages. Each message includes a CAN identifier (CAN ID), data bytes, and control bits. The CAN bus 110 may employ a multi-master architecture, in that any device on the network can initiate a message transmission. This distributed architecture allows for efficient communication between vessel components without the need for a centralized controller. In a particular example, the CAN bus 110 may implement the NMEA2000 protocol, a standard set forth by the National Marine Electronics Association. NMEA2000 provides optimization and messaging for a marine environment.

Vessel 100 can also include a high voltage interlock loop (HVIL) system, which is a safety feature designed to ensure the safe operation and maintenance of the high-voltage components. HVIL is a dedicated circuit that ensures the high voltage connectors are well inserted in the equipment mating connector to ensure the safety of the high voltage connections. HVIL is used by the high voltage battery BMS and the vessel control unit 108 to confirm the integrity of these connections before applying high voltage energy to each high voltage device in the vessel.

For ease of reference, in FIG. 1A power interconnects 111 supplying high voltage power are shown in hash-filled lines, data interconnects for CAN bus 110 are shown in thick solid black lines, and HVIL interconnects 113 are shown in dashed lines.

For further explanation, FIG. 1B sets forth a block diagram of an example of the electric marine propulsion system 102 in accordance with at least one embodiment of the present disclosure. The example marine propulsion system 102 of FIG. 1B includes a CAN interface 121 for coupling the marine propulsion system 102 to the CAN bus 110. For example, the CAN interface 121 may be a network interface controller configured to send and receive messages in the form of CAN frames over the CAN bus 110.

The example marine propulsion system 102 also includes a power control unit (PCU) 199 having a controller 122 coupled to the CAN interface 121. The controller 122 may include or implement a processor, a microcontroller, an Application Specific Integrated Circuit (ASIC), a programmable logic array (PLA) such as a field programmable gate array (FPGA), or other data processing unit in accordance with the present disclosure. In some examples, the controller is implemented by a processor or central processing unit configured to execute computer programming instructions, also referred to a computer executable instructions or processor executable instruction. Such instruction can be loaded from and stored in one or more memory devices collectively referred to as storage 123. Storage 123 may include electrically erasable programmable read-only memory (EEPROM) such as Flash memory (e.g., NAND and NOR flash memory or other types of solid-state memory), dynamic random-access memory (DRAM), static RAM (SRAM), magnetic disk storage, and the like. The storage 123 may be integrated with the controller 122 or provided as a separate memory device coupled to the controller 122.

The marine propulsion system 102 also includes an inverter 129 that is powered by the high voltage batteries 103. The inverter 129 functions to convert the DC current received from the high voltage batteries 103 to alternating current (AC) that can be used by an electric motor. In some examples, the inverter 129 is a high voltage two-phase DC to a high voltage three-phase AC converter. The marine propulsion system also includes an electric motor 124 coupled to a propeller/impeller 125. The electric motor 124 is powered by the current received from the inverter 129. The electric motor 124 is an electric traction motor that turns a drive shaft (not shown) that drives the propeller/impeller 125. In some examples, the electric motor is a permanent magnet electric motor. The electric motor 124 is designed to withstand exposure to water and corrosive marine environments, featuring waterproof enclosures, sealed bearings, and corrosion-resistant materials to ensure reliable operation in wet conditions. The electric motor 124 operates quietly, producing minimal noise and vibration compared to traditional combustion engines, which contributes to a quieter boating experience as well as reduced noise pollution in aquatic environments. The electric motor 124 offers high efficiency and energy density, allowing electric boats to achieve comparable performance to traditional boats powered by combustion engines while using less energy and producing fewer emissions.

A control program 127 embodied in computer programing instructions is stored within tangible persistent storage of storage 123. When executed by the controller 122, the control program 127 is configured to receive commands from the vessel control unit 108 and control the electric motor 124 in accordance with those commands. For example, the control program 127 may be configured to regulate the distribution of electrical energy from the inverter 129 to the electric motor 124. In this example, the control program 127 may receive a throttle/speed command from the vessel control unit 108 and determine the frequency variation or voltage variation that will enter the electric motor 124 for controlling the vessel's speed. The control program 127 is further configured to receive motor state information from various sensors (not shown) and supply motor state information and diagnostic information to the vessel control unit 108.

Also stored in tangible persistent storage of storage 123 is a torque fuse program 126 for implementing a torque fuse in an electric marine propulsion system. The torque fuse program 126 directs the inverter to supply power to an electric motor of an electric marine propulsion system for a watercraft. The torque fuse program 126 also receives sensor data indicating a rotational speed of the electric motor and receives from the inverter, a torque value for the electric motor. The torque fuse program 126 determines whether the rotational speed of the electric motor is at or below a first threshold and the torque value is at or above a second threshold. In response to determining that the rotational speed of the electric motor is at or below the first threshold and the torque value is at or above a second threshold, the torque fuse program 126 directs the inverter to not supply the power to the electric motor.

For further explanation, FIG. 1C sets forth a block diagram of an example of the high voltage battery 103 in accordance with at least one embodiment of the present disclosure. The example high voltage battery 103 of FIG. 1C includes a CAN interface 131 for coupling the high voltage battery 103 to the CAN bus 110. For example, the CAN interface 131 may be a network interface controller configured to send and receive messages in the form of CAN frames over the CAN bus 110. The example high voltage battery 103 includes array of battery cells 135 organized into battery modules 140 or battery packs, and a set of battery contactors 137 that selectively couple the battery modules 140 to high voltage terminals 138 of the battery 103.

The example high voltage battery 103 also includes a battery management system (BMS) 134 comprising a controller 132 coupled to the CAN interface 131. Controller 132 may include or implement a processor, a microcontroller, an ASIC, PLA such as an FPGA, or other data processing unit in accordance with the present disclosure. In some examples, controller 132 is implemented by a processor or central processing unit configured to execute computer programming instructions, also referred to a computer executable instructions or processor executable instruction. Such instructions can be loaded from and stored in one or more memory devices collectively referred to as storage 133. Storage 133 may include EEPROM such as Flash memory (e.g., NAND and NOR flash memory or other types of solid-state memory), DRAM, SRAM, magnetic disk storage, and the like. The battery management system 134 further includes a variety of sensors (not shown) coupled to battery cells for measuring battery state information. The storage 133 may be integrated with the controller 132 or provided as a separate memory device coupled to the controller 132.

The BMS 134 includes a control program 139 embodied in computer programing instructions stored in tangible persistent storage of storage 133. In some examples, the control program 139 controls the state of the battery contactors for selectively coupling and decoupling the battery modules 140 to the high voltage terminals 138 of the battery 103. In some examples, the control program 139 also monitors battery state information such as voltage, current, and temperature in battery cells 135 via the above-mentioned sensors. In some examples, the control program 139 also communicates with the vessel control unit 108 to provide battery state information. The control program also controls the charging of the battery cells 135.

For further explanation, FIG. 1D sets forth a block diagram of an example of the PDU 104 in accordance with at least one embodiment of the present disclosure. The example PDU 104 of FIG. 1D includes a CAN interface 141 for coupling the PDU 104 to the CAN bus 110. For example, the CAN interface 141 may be a network interface controller configured to send and receive messages in the form of CAN frames over the CAN bus 110. The PDU 104 also includes a battery interface 144 coupling the high voltage batteries 103 to a switching system 145 of the PDU 104, a charge port interface 150 coupling the charging port 105 to the switching system 145, a motor interface 147 coupling the marine propulsion system 102 to the switching system 145, and a DCDC interface 148 coupling the DCDC converter 106 to the switching system 145. The switching system 145 includes a set of contactors (not shown for simplicity) by which the PDU 104 supplies power from the high voltage batteries 103 to the marine propulsion system 102 and to the DCDC converter 106, or supplies power from the charging port 105 to the high voltage batteries 103.

The example PDU 104 also includes a controller 142 that may include or implement a processor, a microcontroller, an ASIC, PLA such as an FPGA, or other data processing unit in accordance with the present disclosure. In some examples, the controller 142 is implemented by a processor or central processing unit configured to execute computer programming instructions, also referred to a computer executable instructions or processor executable instruction. Such instructions can be loaded from and stored in one or more memory devices collectively referred to as storage 143. Storage 143 may include EEPROM such as Flash memory (e.g., NAND and NOR flash memory or other types of solid-state memory), DRAM, SRAM, magnetic disk storage, and the like. The storage 143 may be integrated with the controller 142 or provided as a separate memory device coupled to the controller 122.

The PDU 104 also includes a control program 149 embodied in computer programing instructions stored in tangible persistent storage of storage 143. When executed by the controller 142, the control program 149 is configured to receive commands from the vessel control unit 108 and control the switching system 145 to connect and disconnect power supplied to vessel components. The control program 149 is also configured to provide state information to vessel control unit 108.

For further explanation, FIG. 1E sets forth a block diagram of an example vessel control unit 108 in accordance with at least one embodiment of the present disclosure. The example vessel control unit 108 of FIG. 1E includes a CAN interface 151 for coupling the vessel control unit 108 to the CAN bus 110. For example, the CAN interface 151 may be a network interface controller configured to send and receive messages in the form of CAN frames over the CAN bus 110.

The example vessel control unit 108 also includes a controller 152 that may include or implement a processor, a microcontroller, an ASIC, PLA such as an FPGA, or other data processing unit in accordance with the present disclosure. In some examples, controller 152 is implemented by a processor or central processing unit configured to execute computer programming instructions, also referred to a computer executable instructions or processor executable instruction. Such instructions can be loaded from and stored in one or more memory devices collectively referred to as storage 153. Storage 153 may include EEPROM such as Flash memory (e.g., NAND and NOR flash memory or other types of solid-state memory), DRAM, SRAM, magnetic disk storage, and the like. The storage 153 may be integrated with the controller 152 or provided as a separate memory device coupled to the controller 152.

The vessel control unit 108 also includes a control program 154 embodied in computer programing instructions stored in tangible persistent storage of storage 153. When executed by controller 152, the control program 154 is configured to send commands to other vessel components and receive state information and diagnostic data from vessel components as discussed above.

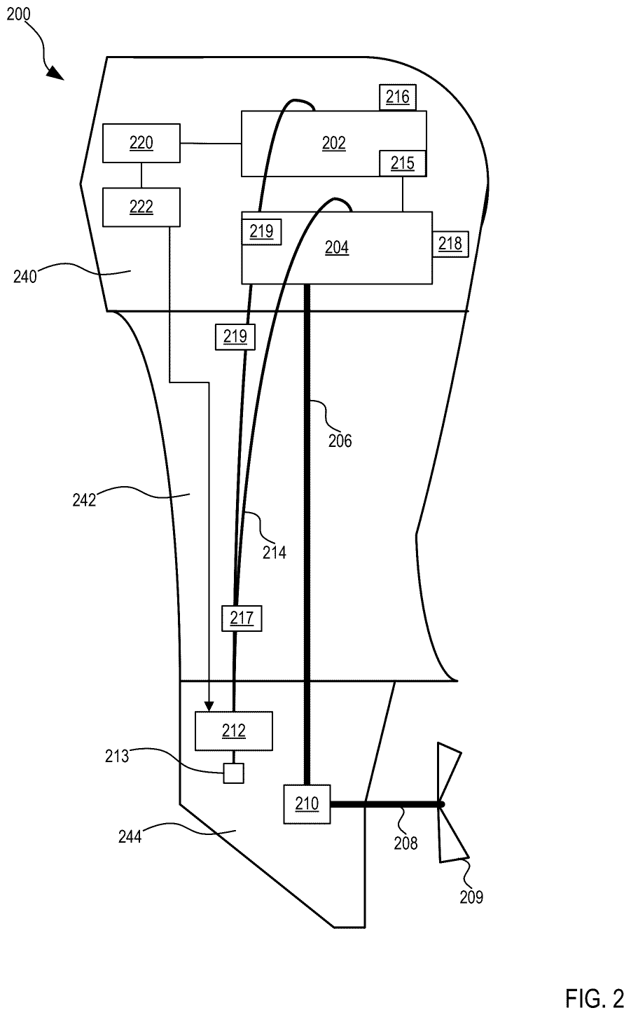

For further explanation, FIG. 2 sets forth a block diagram of an example electric propulsion device 200 that implements a torque fuse in accordance with at least one embodiment of the present disclosure. In some examples, the electric propulsion device 200 is an outboard motor, as depicted. However, it will be appreciated that the electric propulsion device 200 may be other types of marine propulsion devices. Where the electric propulsion device 200 is an outboard motor, the electric propulsion device 200 may be partitioned into an upper unit 240, a middle unit 242, and a lower unit 244. The example electric propulsion device 200 may be similar to the marine propulsion system 102 in FIGS. 1A and 1B. For example, the electric propulsion device 200 includes an inverter 202 that supplies electrical energy to an electric motor 204. The electric motor 204 turns a vertical drive shaft 206 that is coupled via a coupler 210 to a horizontal propeller shaft 208 that drives a propeller 209.

The electric propulsion device 200 also includes a cooling system that is comprised of a water intake pump 212 that pumps ambient water into cooling system via an inlet 213. The cooling system also includes water distribution lines 214 that circulate the water around the components of the electric propulsion device 200 such as the inverter 202 and electric motor 204. In some examples, the cooling system may include water jackets or other structures that bring the water in the distribution lines 214 into thermal contact with the electric propulsion system components. The cooling system also includes one or more water temperature sensors 216 that report temperature readings of the water in the distribution lines 214. The cooling system also includes one or more flow rate sensors 217 that detect the rate of flow of the water in the distribution lines 214. The electric propulsion device 200 also includes one or more temperature sensors 218 located on or proximate to the inverter 202 and the electric motor 204. The temperature sensors 218 may report temperature readings of a contact surface (e.g., the electric motor casing) or ambient temperature. The electric propulsion device 200 also includes a motor speed sensor 219 configured to output the rotational speed of the motor. The electric propulsion device 200 also includes one or more current sensors that output a reading of the electric current at various points in a power distribution system, including a current sensor 215 that outputs a reading of the current applied by the inverter 202 to the electric motor 204. The current sensor can be, for example, a sensor in the inverter 202.

The electric propulsion device 200 also includes a power control unit 220. The power control unit 220 is configured to receive commands from the vessel control unit and control the inverter 202 in accordance with those commands. For example, power control unit 220 may be configured to regulate the distribution of electrical energy from the inverter 202 to the electric motor 204. In this example, power control unit 220 may receive a throttle/speed command from the vessel control unit and determine the frequency variation or voltage variation that will enter the electric motor for controlling the vessel's speed. The controller 220 is also configured to receive TRIM commands from the vessel control unit and operate a rutter in accordance with the TRIM commands and the TRIM sensor value embedded in the outboard.

The power control unit 220 is configured to direct the inverter 202 to supply power to the electric motor 204. The power control unit 220 is also configured to receive sensor data indicating a rotational speed of the electric motor and a torque value for the electric motor. In a particular embodiment, the power control unit is configured to receive data from various sensors such as the current sensor 215, temperature sensors 216, 218, flow rate sensor 217, and motor speed sensor 219. The power control unit 220 is also configured to determine whether the rotational speed of the electric motor 204 is at or below a first threshold and the torque value is at or above a second threshold. In response to determining that the rotational speed of the electric motor is at or below the first threshold and the torque value is at or above a second threshold, the power control unit is configured to direct the inverter to not supply the power to the electric motor.

The electric propulsion device 200 also includes a pump controller 222. The pump controller 222 may be an electronic control unit that is separate from the power control unit 220 (as depicted), or may be integrated with the power control unit 220. For example, the pump controller 222 may be a submodule of the power control unit 220. The pump controller 222 controls the water intake pump 212 of the cooling system for the electric propulsion.

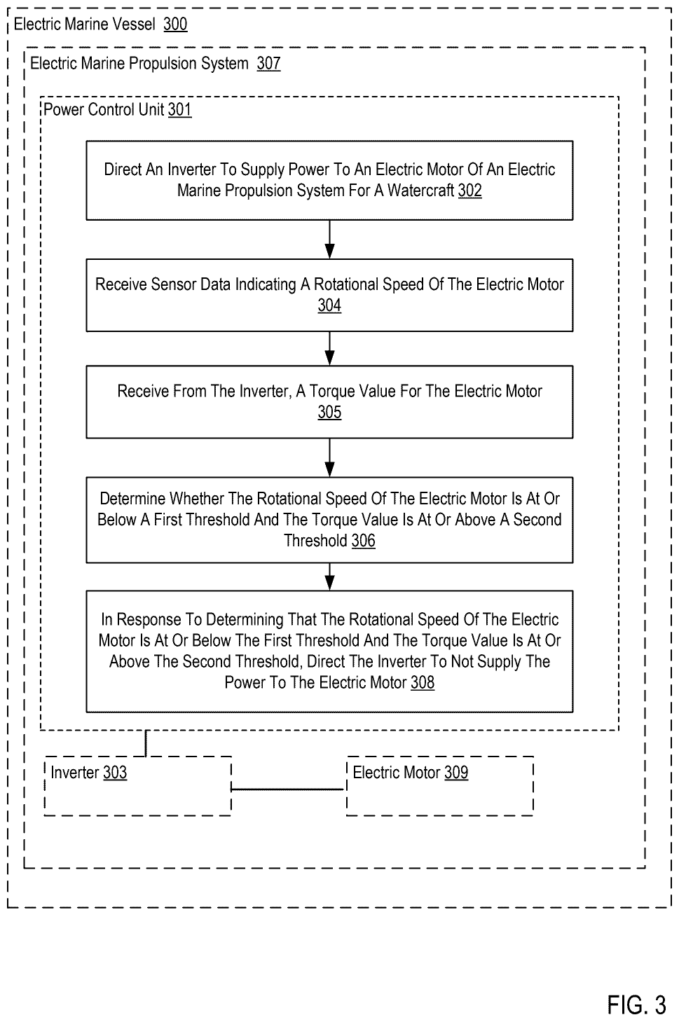

For further explanation, FIG. 3 sets forth a flow chart of an example method for implementing a torque fuse in an electric marine propulsion system 307 in accordance with at least one embodiment of the present disclosure. The example of FIG. 3 includes an electric marine vessel 300. The electric marine vessel includes an electric marine propulsion system (e.g., a full-electric outboard motor) 307 and high voltage battery packs for supplying electricity to the electric propulsion system. The electric propulsion system includes a power control unit 301 and an inverter 303 that receives power from the battery packs and converts the power into energy that is used to actuate an electric motor 309. The electric motor 309 drives a propeller of the electric marine propulsion system 307 via a rotating drive shaft and a coupler. The marine vessel 300 may include additional powertrain components as described above. During operation, the marine vessel is waterborne on a body of water (e.g., an ocean, river, lake, etc.). The inverter, electric motor and other components of the electric propulsion device are cooled via ambient water from the body of water.

In some examples, the power control unit 301 is a standalone electronic control unit. In other examples, the power control unit may be a module that is integrated into another electronic control unit of the marine propulsion device, a vessel control unit, and so on. In some examples, the power control unit is embodied in a set of computer programming instructions that, when executed by a processor, cause the processor to carry out the operations shown in FIG. 3.

The method of FIG. 3 includes directing 302, by a power control unit 301, an inverter 303 to supply power to an electric motor 309 of an electric marine propulsion system 307 for a watercraft. The power control unit 301 may be configured to receive commands from the vessel control unit and control the inverter 303 in accordance with those commands. For example, power control unit 301 may be configured to regulate the distribution of electrical energy from the inverter 303 to the electric motor 309. In this example, power control unit 301 may receive a throttle/speed command from the vessel control unit and determine the frequency variation or voltage variation that will enter the electric motor for controlling the vessel's speed. Directing 302, by a power control unit 301, an inverter 303 to supply power to an electric motor 309 of an electric marine propulsion system 307 for a watercraft may be carried out by sending to the inverter a control signal, message, or command that indicates power parameters associated with the desired power output of the inverter. Power parameters may indicate particular a frequency or voltage level.

The method of FIG. 3 also includes receiving 304, by the power control unit 301, sensor data indicating a rotational speed of the electric motor 309. Sensor data may include various information describing the state of the electric propulsion system, such as the speed and temperature of the electric motor, the temperature of the water in the cooling system, the flow rate of water in the cooling system, the current drawn by the electric motor, the amount of throttle applied to the electric motor, and so on. In some examples, at least some of the information is collected by sensors in the electric propulsion system. For example, a motor speed sensor can report the revolutions per minute (RPM) of the electric motor, while a current sensor can report the current draw of the inverter, or the current supplied to the electric motor. In some implementations, the power control unit 301 receives at least some of the sensor data directly from these sensors. In some implementations, the power control unit 301 receives at least some of the information from other electronic control units, such as the vessel control unit. In some examples, the power control unit 301 is coupled to a CAN bus for communication with other vessel components, such as the vessel control unit. In such examples, sensor data and information describing the state of the electric propulsion device can be received via the CAN bus from other electronic control units. In some implementations, at least part of the information is received in one or more data messages, packets, or frames.

In some implementations, the power control unit 301 determines the motor speed of the electric motor by identifying data or values in the received sensor data that are indicative of motor speed. In some implementations, the power control unit 301 determines the motor speed from the information by identifying RPM data in the information, such as the number of revolutions per minute of the drive shaft in the electric propulsion device.

The method of FIG. 3 also includes receiving 305 from the inverter 303, by the power control unit 301, a torque value for the electric motor. A torque value may be an indication of a torque provided by the electric motor. Receiving 305 from the inverter 303, by the power control unit 301, a torque value for the electric motor may be carried out by receiving periodic transmission of a current torque value from the inverter directly or via one or more communication pathways, such as a CAN bus.

The method of FIG. 3 also includes determining 306, by the power control unit 301, whether the rotational speed of the electric motor 309 is at or below a first threshold and the torque value is at or above a second threshold. The first threshold may be selected to correspond to a minimum rotational speed below which the propeller is determined to be stuck or blocked. For example, the first threshold may be set to zero or a speed slightly above zero. The second threshold may be selected to correspond to a minimum torque level provided by the electric motor to the drive shaft, propeller, and the rest of the marine propulsion system. Determining 306, by the power control unit 301, whether the rotational speed of the electric motor 309 is at or below a first threshold and the torque value is at or above a second threshold may be carried out by comparing the rotational speed of the electric motor to the first threshold and comparing the torque value to the second threshold.

The method of FIG. 3 also includes in response to determining that the rotational speed of the electric motor 309 is at or below the first threshold and the torque value is at or above the second threshold, directing 308, by the power control unit 301, the inverter 303 to not supply the power to the electric motor. Directing 308, by the power control unit 301, the inverter 303 to not supply the power to the electric motor may be carried out by sending to the inverter a control signal, message, or command that indicates the inverter should shut down the supply of the power to the electric motor.

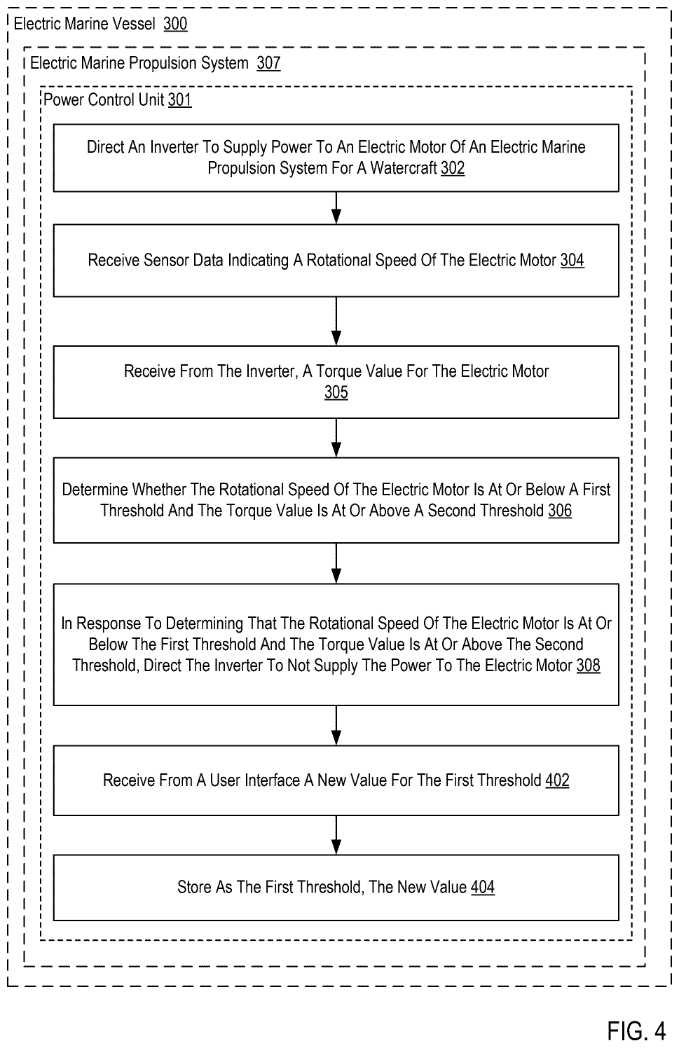

For further explanation, FIG. 4 sets forth a flow chart of another example method of implementing a torque fuse in an electric marine propulsion system 307 in accordance with at least one embodiment of the present disclosure. The example method of FIG. 4 extends the method of FIG. 3 in that the method of FIG. 4 includes receiving 402 from a user interface 401, by the power control unit 301, a new value for the first threshold. Thresholds of the power control unit may be programmed by a handheld device that is separate from the marine vessel, such as a mobile or handheld device, or by a device of the marine vessel. In either instance, the device may execute a control program that generates a user interface that allows a user to control and set various thresholds and parameters associated with the power control unit and the electric marine propulsion system. The control program may transmit the new value for a threshold directly to the power control unit via a wireless connection or via a wired connection, such as the CAN bus. Receiving 402 from a user interface 401, by the power control unit 301, a new value for the first threshold may be carried out by receiving via a wireless or wired connection, a message or data indicating the new value.

The method of FIG. 4 also includes storing 404 as the first threshold, by the power control unit 301, the new value. Storing 404 as the first threshold, by the power control unit 301, the new value may be carried out by recording the new value in a storage unit coupled to a processor of the power control unit.

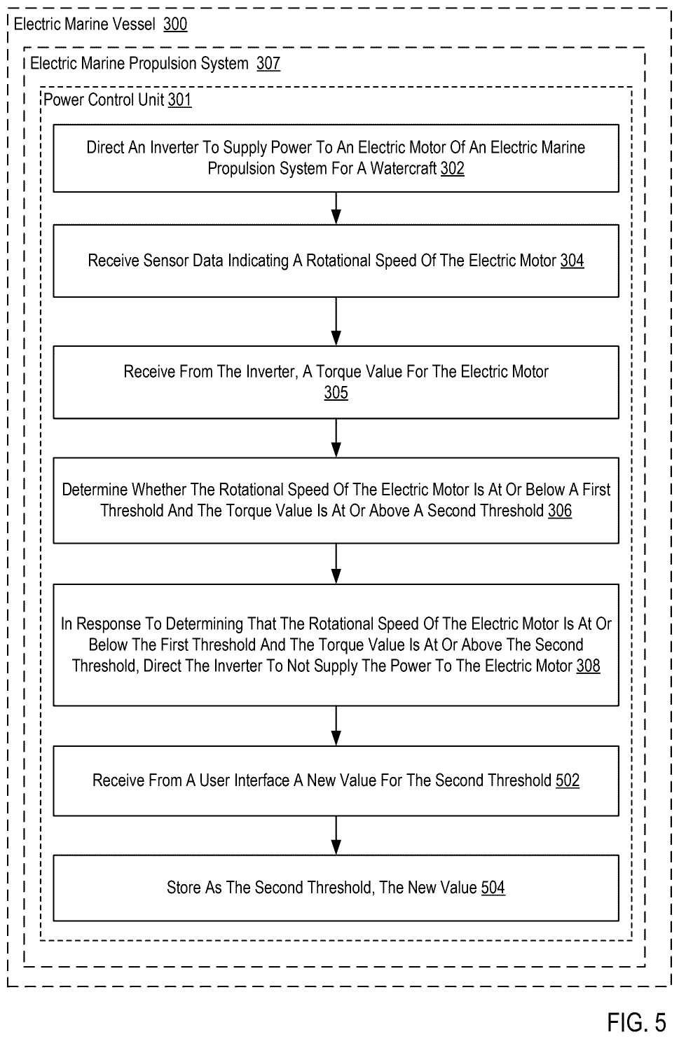

For further explanation, FIG. 5 sets forth a flow chart of another example method of implementing a torque fuse in an electric marine propulsion system 307 in accordance with at least one embodiment of the present disclosure. The example method of FIG. 5 extends the method of FIG. 3 in that the method of FIG. 5 also includes receiving 502 from a user interface, by the power control unit 301, a new value for the second threshold. Thresholds of the power control unit may be programmed by a handheld device that is separate from the marine vessel, such as a mobile or handheld device, or by a device of the marine vessel. In either instance, the device may execute a control program that generates a user interface that allows a user to control and set various thresholds and parameters associated with the power control unit and the electric marine propulsion system. The control program may transmit the new value directly to the power control unit via a wireless connection or via a wired connection, such as the CAN bus. Receiving 502 from a user interface, by the power control unit 301, a new value for the second threshold may be carried out by receiving via a wireless or wired connection, a message or data indicating the new value.

The method of FIG. 5 also includes storing 504 as the second threshold, by the power control unit 301, the new value. Storing 504 as the second threshold, by the power control unit 301, the new value may be carried out by recording the new value in a storage unit coupled to a processor of the power control unit.

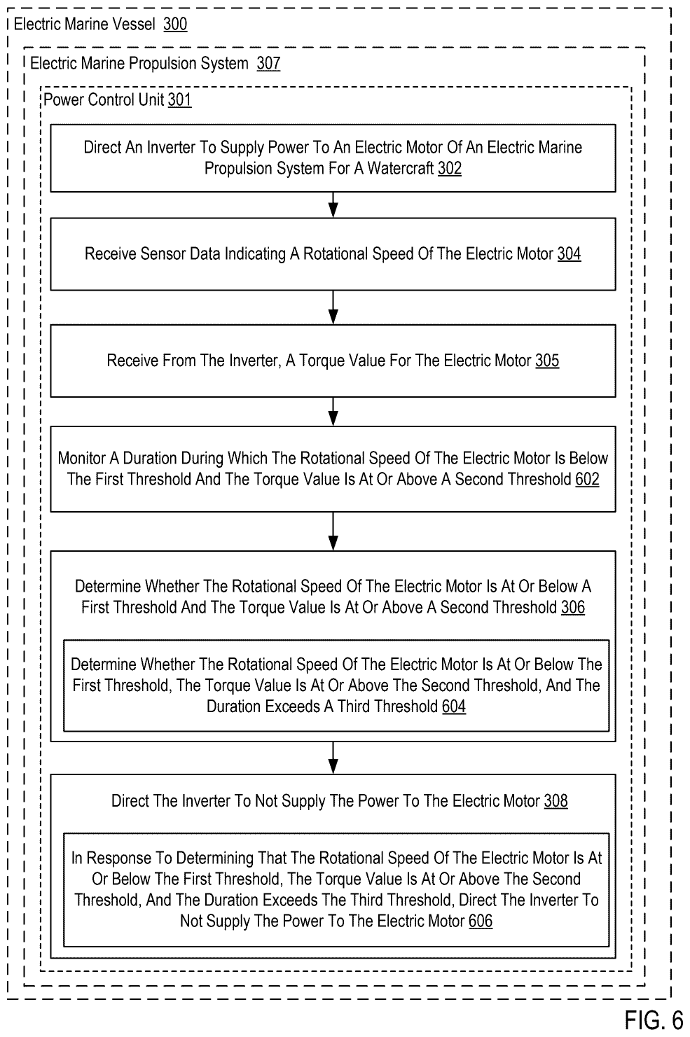

For further explanation, FIG. 6 sets forth a flow chart of another example method of implementing a torque fuse in an electric marine propulsion system 307 in accordance with at least one embodiment of the present disclosure. The example method of FIG. 6 extends the method of FIG. 3 in that the method of FIG. 6 includes monitoring 602, by the power control unit 301, a duration during which the rotational speed of the electric motor 309 is at or below the first threshold and the torque value is at or above the second threshold. Monitoring 602, by the power control unit 301, a duration during which the rotational speed of the electric motor 309 is at or below the first threshold and the torque value is at or above the second threshold may be carried out by starting a timer that periodically increments while the rotational speed of the electric motor is at or below the first threshold and the torque value is at or above the second threshold. In a particular embodiment, the timer is stopped or reset in response to the power control unit detecting or determining that the rotational speed of the electric motor exceeds the first threshold or the torque value is below the second threshold. In this example, if the propeller becomes unstuck and the speed of the electric motor exceeds the first threshold, then the timer is reset.

In the example of FIG. 6, determining 306, by the power control unit 301, whether the rotational speed of the electric motor 309 is at or below the first threshold and the torque value is at or above a second threshold includes determining 504, by the power control unit 301, whether the rotational speed of the electric motor 309 is at or below the first threshold, the torque value is at or above the second threshold, and that the duration exceeds a third threshold. The third threshold may be selected to correspond to a minimum amount of time that the speed of the electric motor should be at or below the first threshold while the torque value is at or above the second threshold to be considered stuck or obstructed. For example, the third threshold may be set to two seconds. In this example, if the electric motor stops spinning for one second and then resumes spinning, then the threshold is not met. Determining 604, by the power control unit 301, whether the rotational speed of the electric motor 309 is at or below the first threshold, the torque value is at or above the second threshold, and that the duration exceeds a third threshold may be carried out by comparing to the third threshold, the timer tracking the duration that the speed of the electric motor is at or below the first threshold and the torque value is at or above the second threshold.

In the example of FIG. 6, in response to determining that the rotational speed of the electric motor 309 is at or below the first threshold and the torque value is at or above a second threshold, directing 308, by the power control unit 301, the inverter 303 to not supply the power to the electric motor includes in response to determining that the rotational speed of the electric motor 309 is at or below the first threshold, the torque value is at or above the second threshold, and the duration exceeds the third threshold, directing 506, by the power control unit 301, the inverter to not supply the power to the electric motor 309. Directing 506, by the power control unit 301, the inverter to not supply the power to the electric motor 309 in response to determining that the rotational speed of the electric motor 309 is at or below the first threshold, the torque value is at or above the second threshold, and that the duration exceeds the third threshold may be carried out by sending to the inverter a control signal, message, or command that indicates the inverter should shut down the supply of the power to the electric motor.

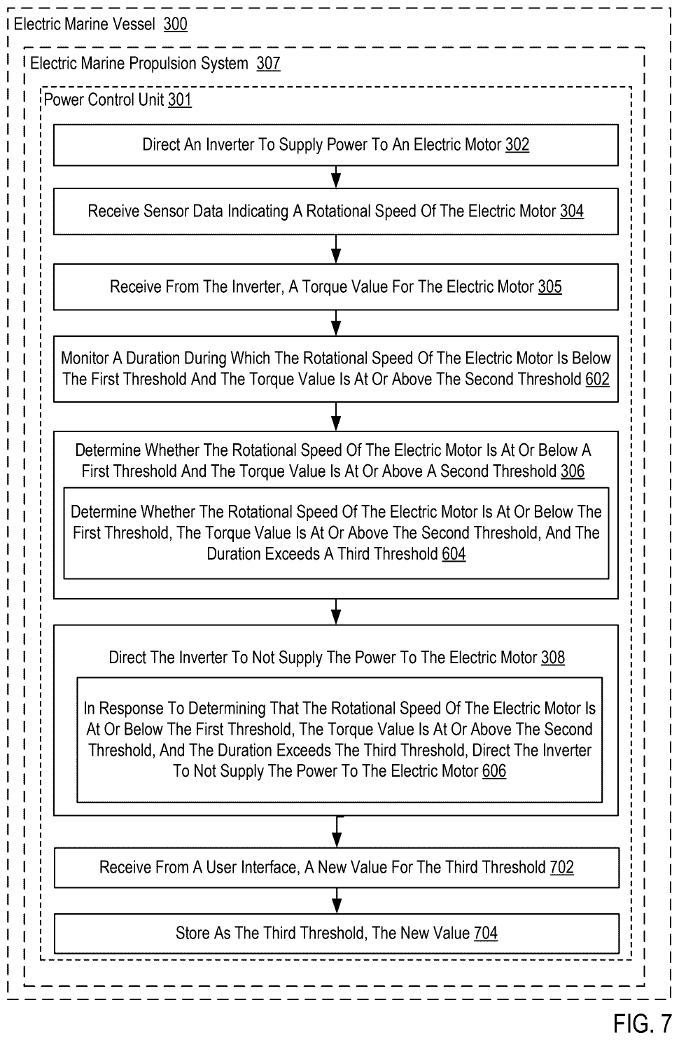

For further explanation, FIG. 7 sets forth a flow chart of another example method of implementing a torque fuse in an electric marine propulsion system 307 in accordance with at least one embodiment of the present disclosure. The example method of FIG. 7 extends the method of FIG. 6 in that the method of FIG. 7 also includes receiving 702 from a user interface, by the power control unit 301, a new value for the third threshold. Thresholds of the power control unit may be programmed by a handheld device that is separate from the marine vessel, such as a mobile or handheld device, or by a device of the marine vessel. In either instance, the device may execute a control program that generates a user interface that allows a user to control and set various thresholds and parameters associated with the power control unit and the electric marine propulsion system. The control program may transmit the new value directly to the power control unit via a wireless connection or via a wired connection, such as the CAN bus. Receiving 702 from a user interface, by the power control unit 301, a new value for the third threshold may be carried out by receiving via a wireless or wired connection, a message or data indicating the new value.

The method of FIG. 7 also includes storing 704 as the third threshold, by the power control unit 301, the new value. Storing 704 as the third threshold, by the power control unit 301, the new value may be carried out by recording the new value in a storage unit coupled to a processor of the power control unit.

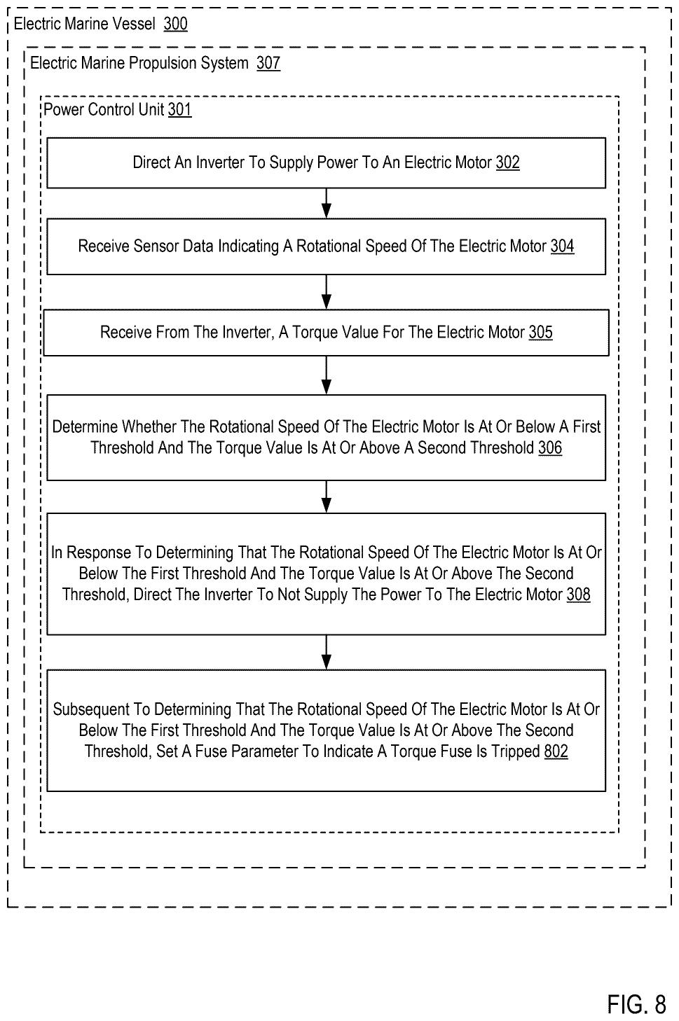

For further explanation, FIG. 8 sets forth a flow chart of another example method of implementing a torque fuse in an electric marine propulsion system 307 in accordance with at least one embodiment of the present disclosure. The example method of FIG. 8 extends the method of FIG. 3 in that the method of FIG. 8 includes subsequent to determining that the rotational speed of the electric motor 309 is at or below the first threshold and the torque value is at or above a second threshold, setting 802, by the power control unit 301, a fuse parameter to indicate a “virtual torque fuse” is tripped. A fuse parameter may be a data value or flag that is used to indicate the state of the “virtual torque fuse”. In this example, the power control unit may use the fuse parameter to indicate that the power control unit has determined that the rotational speed of the electric motor is at or below the first threshold and the torque value is at or above a second threshold. Setting 802, by the power control unit 301, a fuse parameter to indicate a torque fuse is tripped may be carried out by storing a specific data value in a memory location corresponding to the fuse parameter.

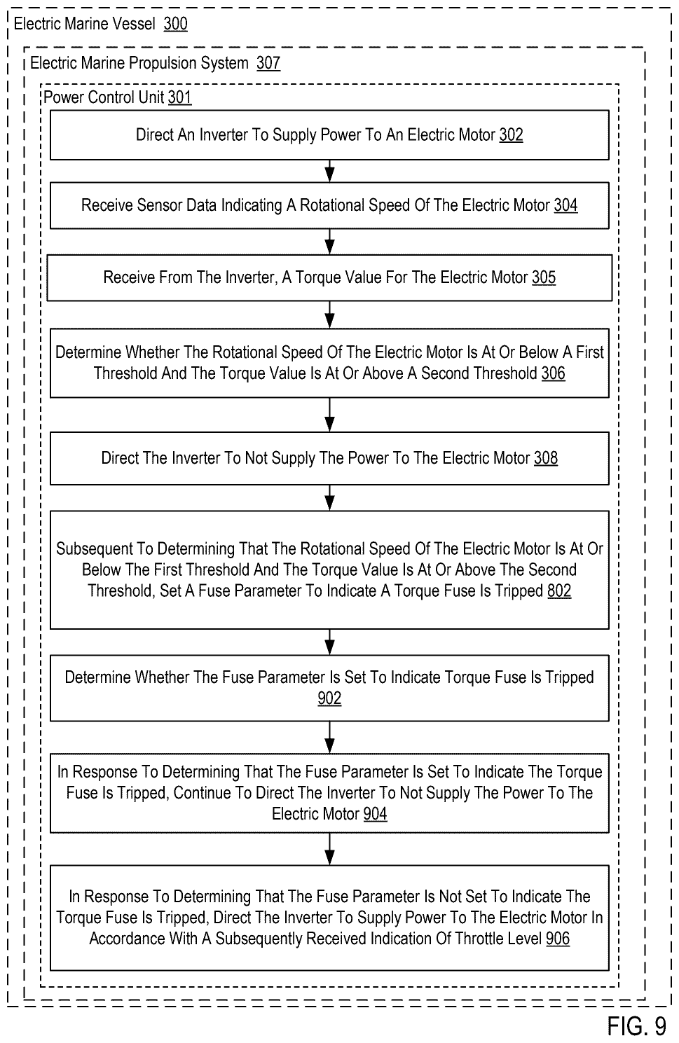

For further explanation, FIG. 9 sets forth a flow chart of another example method of implementing a torque fuse in an electric marine propulsion system 307 in accordance with at least one embodiment of the present disclosure. The example method of FIG. 9 extends the method of FIG. 8 in that the method of FIG. 9 includes determining 902, by the power control unit 301, whether the fuse parameter is set to indicate torque fuse is tripped. Determining 902, by the power control unit 301, whether the fuse parameter is set to indicate torque fuse is tripped may be carried out by retrieving a data value stored at a particular location associated with the fuse parameter.

The method of FIG. 9 also includes in response to determining that the fuse parameter is set to indicate the torque fuse is tripped, continuing 904, by the power control unit 301, to direct the inverter 303 to not supply the power to the electric motor 309. Continuing 904, by the power control unit 301, to direct the inverter 303 to not supply the power to the electric motor 309 in response to determining that the fuse parameter is set to indicate the torque fuse is tripped may be carried out by ignoring throttle commands and messages; and sending to the inverter a control signal, message, or command indicating the inverter should maintain a shutdown of the supply of the power to the electric motor.

The method of FIG. 9 also includes in response to determining that the fuse parameter is not set to indicate the torque fuse is tripped, directing 906, by the power control unit 301, the inverter 303 to supply power to the electric motor 309 in accordance with a subsequently received indication of throttle level. Directing 906, by the power control unit 301, the inverter 303 to supply power to the electric motor 309 in accordance with a subsequently received indication of throttle level in response to determining that the fuse parameter is not set to indicate the torque fuse is tripped may be carried out by sending to the inverter a control signal, message, or command that indicates the inverter should supply the power to the electric motor.

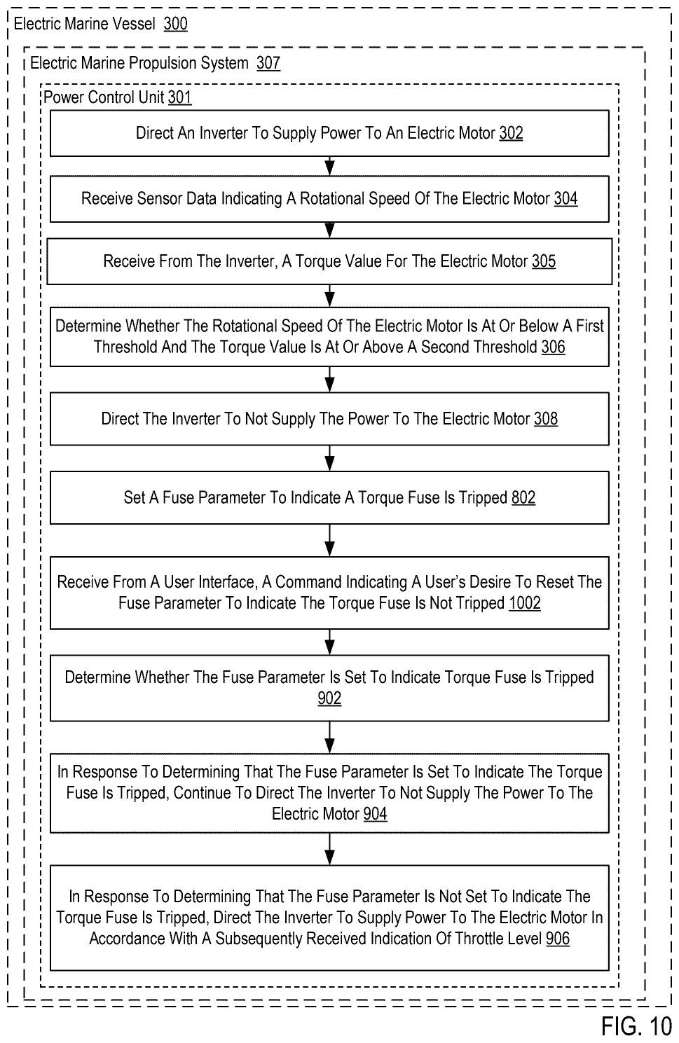

For further explanation, FIG. 10 sets forth a flow chart of another example method of implementing a torque fuse in an electric marine propulsion system 307 in accordance with at least one embodiment of the present disclosure. The example method of FIG. 10 extends the method of FIG. 9 in that the method of FIG. 10 includes receiving 1002 from a user interface, by the power control unit 301, a command indicating a user's desire to reset the fuse parameter to indicate the torque fuse is not tripped. In a particular embodiment, the power control unit may notify a user via one or more other components of the marine vessel or mobile device that the “virtual torque fuse” has been tripped. That is, the user may be notified that the system has determined the propeller is stuck and the power to the electric motor has been shut down. In response to receiving this message, the user may attempt to clear the obstruction or determine another cause for this issue. In either case, the user may determine that the issue has been resolved and consequently decide to resume operation of the marine propulsion system. For example, the user may select via a user interface (e.g., mobile device, device of the marine vessel) an option indicating the user's desire to reset the fuse parameter.

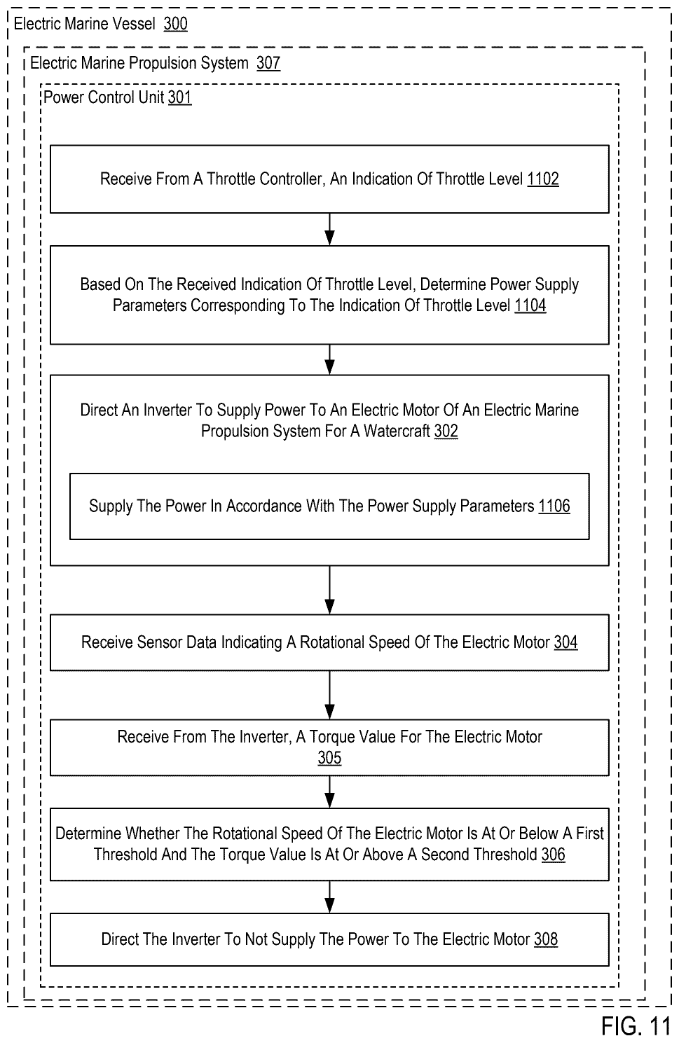

For further explanation, FIG. 11 sets forth a flow chart of another example method of implementing a torque fuse in an electric marine propulsion system 307 in accordance with at least one embodiment of the present disclosure. The example method of FIG. 11 extends the method of FIG. 3 in that the method of FIG. 11 includes receiving 1102 from a throttle controller, by the power control unit 301, an indication of throttle level. Receiving 1102 from a throttle controller, by the power control unit 301, an indication of throttle level may be carried out by receiving throttle/speed command from the vessel control unit or other component of the marine vessel.

The method of FIG. 11 also includes determining 1104 based on the received indication of throttle level, by the power control unit 301, power supply parameters corresponding to the indication of throttle level. Determining 1104 based on the received indication of throttle level, by the power control unit 301, power supply parameters corresponding to the indication of throttle level may be carried out by determining the frequency variation or voltage variation that will enter the electric motor for controlling the vessel's speed.

In the method of FIG. 11, directing 302, by a power control unit 301, an inverter 303 to supply power to an electric motor 309 that drives an electric marine propulsion system 307 of a watercraft includes supplying 1106 the power in accordance with the power supply parameters. Supplying 1106 the power in accordance with the power supply parameters may be carried out by sending to the inverter a control signal, message, or command that indicates power parameters associated with the desired power output of the inverter.

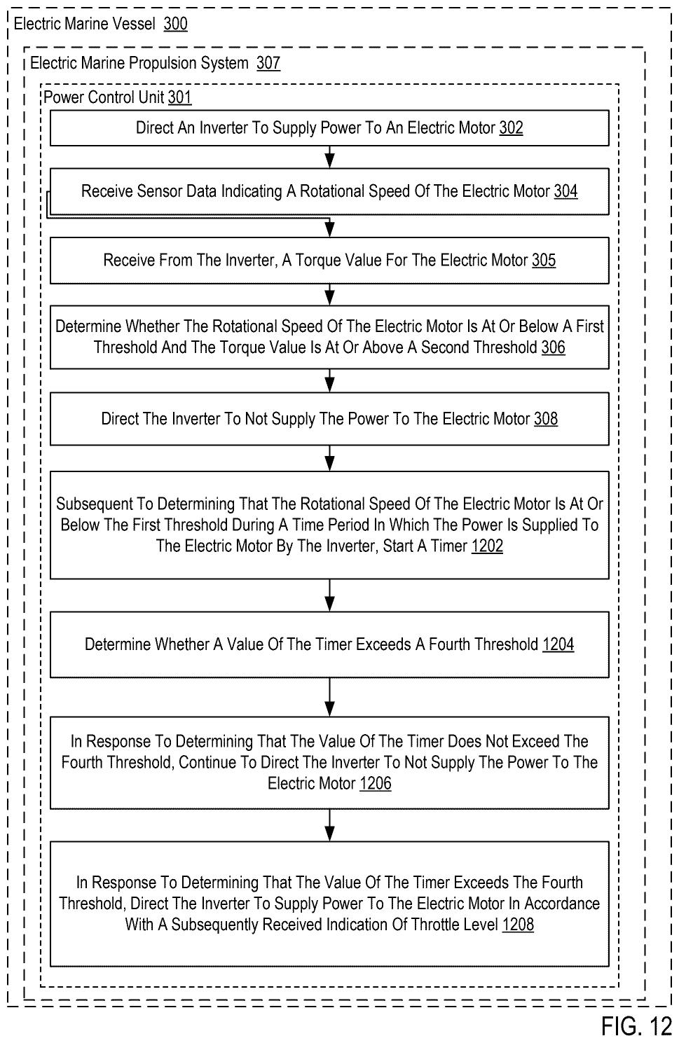

For further explanation, FIG. 12 sets forth a flow chart of another example method of implementing a torque fuse in an electric marine propulsion system 307 in accordance with at least one embodiment of the present disclosure. The example method of FIG. 12 extends the method of FIG. 3 in that the method of FIG. 12 includes subsequent to determining that the rotational speed of the electric motor 309 is at or below the first threshold and the torque value is at or above a second threshold, starting 1202, by the power control unit 301, a timer. In this embodiment, a timer may be utilized to track the amount of time following the power control unit determining that the rotational speed of the electric motor is at or below the first threshold and the torque value is at or above the second threshold.

The method of FIG. 12 includes determining 1204, by the power control unit 301, whether a value of the timer exceeds a fourth threshold. Determining 1204, by the power control unit 301, whether a value of the timer exceeds a fourth threshold may be carried out by comparing the fourth threshold to the value of the timer.

The method of FIG. 12 also includes in response to determining that the value of the timer does not exceed the fourth threshold, continuing 1206, by the power control unit 301, to direct the inverter 303 to not supply the power to the electric motor 309. Continuing 1206, by the power control unit 301, to direct the inverter 303 to not supply the power to the electric motor 309 in response to determining that the value of the timer does not exceed the fourth threshold may be carried out by ignoring throttle commands and messages; and sending to the inverter a control signal, message, or command indicating the inverter should maintain a shutdown of the supply of the power to the electric motor.

The method of FIG. 12 also includes in response to determining that the value of the timer exceeds the fourth threshold, directing 1208, by the power control unit 301, the inverter 303 to supply power to the electric motor 309 in accordance with a subsequently received indication of throttle level. Directing 1208, by the power control unit 301, the inverter 303 to supply power to the electric motor 309 in accordance with a subsequently received indication of throttle level in response to determining that the value of the timer exceeds the fourth threshold may be carried out by sending to the inverter a control signal, message, or command that indicates the inverter should supply the power to the electric motor.

The fourth threshold may be selected to correspond to a duration of time during which the system is shutdown following the virtual torque fuse being tripped (i.e., a determination by the power control unit that the rotational speed of the electric motor is at or below the first threshold and the torque value is at or above a second threshold). That is, the fourth threshold may be selected as a “cool down” period for the user notified that there is an issue and the marine power propulsion system to be examined. For example, the fourth threshold may be thirty seconds. In this example, if the fourth threshold is not exceeded, then the power control unit maintains the shutdown of power to the electric motor and if the fourth threshold is exceeded, then the power control unit restores power to the electric motor.

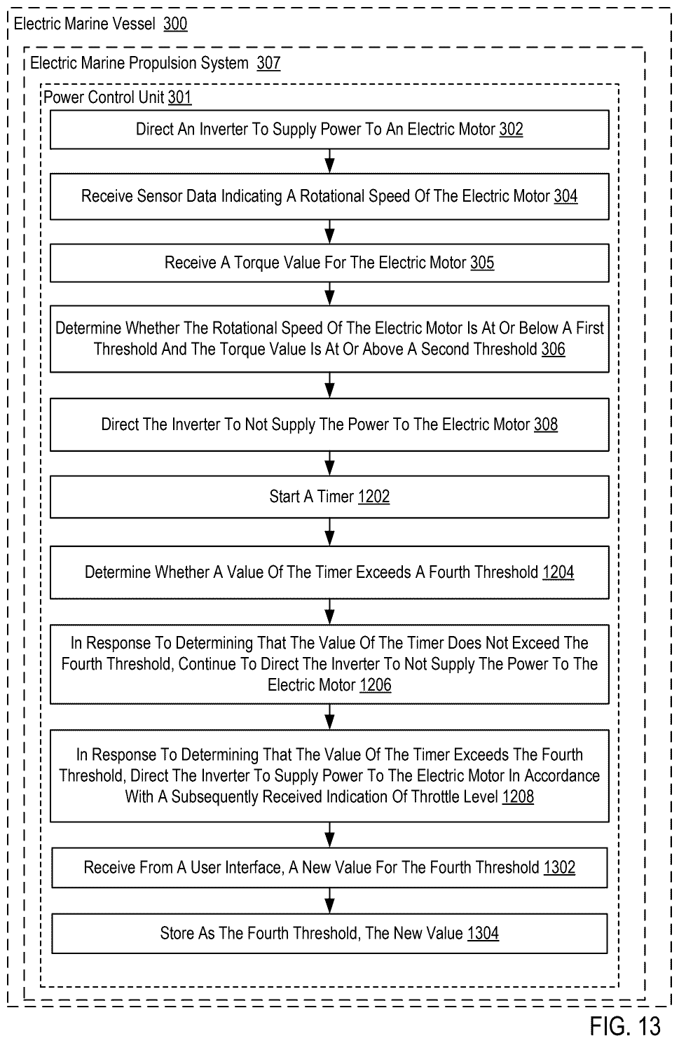

For further explanation, FIG. 13 sets forth a flow chart of another example method of implementing a torque fuse in an electric marine propulsion system 307 in accordance with at least one embodiment of the present disclosure. The example method of FIG. 13 extends the method of FIG. 12 in that the method of FIG. 13 includes receiving 1302 from a user interface, by the power control unit 301, a new value for the fourth threshold. Thresholds of the power control unit may be programmed by a handheld device that is separate from the marine vessel, such as a mobile or handheld device, or by a device of the marine vessel. In either instance, the device may execute a control program that generates a user interface that allows a user to control and set various thresholds and parameters associated with the power control unit and the electric marine propulsion system. The control program may transmit the new value directly to the power control unit via a wireless connection or via a wired connection, such as the CAN bus. Receiving 1302 from a user interface, by the power control unit 301, a new value for the fourth threshold may be carried out by receiving via a wireless or wired connection, a message or data indicating the new value.

The method of FIG. 13 also includes storing 1304 as the fourth threshold, by the power control unit, the new value. Storing 1304 as the fourth threshold, by the power control unit, the new value may be carried out by recording the new value in a storage unit coupled to a processor of the power control unit.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of implementing a torque fuse in an electric marine propulsion system with a torque fuse, the method comprising:
directing, by a power control unit, an inverter to supply power to an electric motor of an electric marine propulsion system for a watercraft;
receiving, by the power control unit, sensor data indicating a rotational speed of the electric motor;
receiving from the inverter, by the power control unit, a torque value for the electric motor;
determining, by the power control unit, whether the rotational speed of the electric motor is at or below a first threshold and the torque value is at or above a second threshold; and
in response to determining that the rotational speed of the electric motor is at or below the first threshold and the torque value is at or above the second threshold, directing, by the power control unit, the inverter to not supply the power to the electric motor.

2. The method of claim 1 further comprising:
receiving from a user interface, by the power control unit, a new value for the first threshold; and
storing as the first threshold, by the power control unit, the new value.

3. The method of claim 1 further comprising:
receiving from a user interface, by the power control unit, a new value for the second threshold; and
storing as the second threshold, by the power control unit, the new value.

4. The method of claim 1 further comprising:
monitoring, by the power control unit, a duration during which the rotational speed of the electric motor is at or below the first threshold and the torque value is at or above a second threshold;
wherein determining, by the power control unit, whether the rotational speed of the electric motor is at or below the first threshold and the torque value is at or above the second threshold includes determining, by the power control unit, whether the rotational speed of the electric motor is at or below the first threshold, the torque value is at or above the second threshold, and the duration exceeds a third threshold; and
wherein in response to determining that the rotational speed of the electric motor is at or below the first threshold and the torque value is at or above the second threshold, directing, by the power control unit, the inverter to not supply the power to the electric motor includes in response to determining that the rotational speed of the electric motor is at or below the first threshold, the torque value is at or above the second threshold, and the duration exceeds the third threshold, directing, by the power control unit, the inverter to not supply the power to the electric motor.

5. The method of claim 4 further comprising:
receiving from a user interface, by the power control unit, a new value for the third threshold; and
storing as the third threshold, by the power control unit, the new value.

6. The method of claim 1 further comprising:
subsequent to determining that the rotational speed of the electric motor is at or below the first threshold and the torque value is at or above the second threshold, setting, by the power control unit, a fuse parameter to indicate a torque fuse is tripped.

7. The method of claim 6 further comprising:
determining, by the power control unit, whether the fuse parameter is set to indicate the torque fuse is tripped;
in response to determining that the fuse parameter is set to indicate the torque fuse is tripped, continuing, by the power control unit, to direct the inverter to not supply the power to the electric motor; and
in response to determining that the fuse parameter is not set to indicate the torque fuse is tripped, directing, by the power control unit, the inverter to supply power to the electric motor in accordance with a subsequently received indication of throttle level.

8. The method of claim 7 further comprising:
receiving from a user interface, by the power control unit, a command indicating a user's desire to reset the fuse parameter to indicate the torque fuse is not tripped.

9. The method of claim 1 further comprising:
receiving from a throttle controller, by the power control unit, an indication of throttle level; and
based on the received indication of throttle level, determining, by the power control unit, power supply parameters corresponding to the indication of throttle level; and
wherein directing, by a power control unit, an inverter to supply power to an electric motor that drives an electric marine propulsion system of a watercraft includes supplying the power in accordance with the power supply parameters.

10. The method of claim 1 further comprising:
subsequent to determining that the rotational speed of the electric motor is at or below the first threshold and the torque value is at or above the second threshold, starting, by the power control unit, a timer;
determining, by the power control unit, whether a value of the timer exceeds a fourth threshold;
in response to determining that the value of the timer does not exceed the fourth threshold, continuing, by the power control unit, to direct the inverter to not supply the power to the electric motor; and
in response to determining that the value of the timer exceeds the fourth threshold, directing, by the power control unit, the inverter to supply power to the electric motor in accordance with a subsequently received indication of throttle level.

11. The method of claim 10 further comprising:
receiving from a user interface, by the power control unit, a new value for the fourth threshold; and
storing as the fourth threshold, by the power control unit, the new value.

12. An apparatus for implementing a torque fuse in an electric marine propulsion system, the apparatus comprising a controller coupled with a memory storing program instructions that when executed by the controller cause the controller to carry out the operations of:
directing, by a power control unit, an inverter to supply power to an electric motor of an electric marine propulsion system for a watercraft;
receiving, by the power control unit, sensor data indicating a rotational speed of the electric motor;
receiving from the inverter, by the power control unit, a torque value for the electric motor;
determining, by the power control unit, whether the rotational speed of the electric motor is at or below a first threshold and the torque value is at or above a second threshold; and
in response to determining that the rotational speed of the electric motor is at or below the first threshold and the torque value is at or above the second threshold, directing, by the power control unit, the inverter to not supply the power to the electric motor.

13. The apparatus of claim 12 wherein the memory stores program instructions that when executed by the controller cause the controller to carry out the operations of:
receiving from a user interface, by the power control unit, a new value for the first threshold; and
storing as the first threshold, by the power control unit, the new value.

14. The apparatus of claim 12 wherein the memory stores program instructions that when executed by the controller cause the controller to carry out the operations of:
receiving from a user interface, by the power control unit, a new value for the second threshold; and
storing as the second threshold, by the power control unit, the new value.

15. The apparatus of claim 12 wherein the memory stores program instructions that when executed by the controller cause the controller to carry out the operations of:
monitoring, by the power control unit, a duration during which the rotational speed of the electric motor is at or below the first threshold and the torque value is at or above a second threshold;
wherein determining, by the power control unit, whether the rotational speed of the electric motor is at or below the first threshold and the torque value is at or above the second threshold includes determining, by the power control unit, whether the rotational speed of the electric motor is at or below the first threshold, the torque value is at or above the second threshold, and the duration exceeds a third threshold; and
wherein in response to determining that the rotational speed of the electric motor is at or below the first threshold and the torque value is at or above the second threshold, directing, by the power control unit, the inverter to not supply the power to the electric motor includes in response to determining that the rotational speed of the electric motor is at or below the first threshold, the torque value is at or above the second threshold, and the duration exceeds the third threshold, directing, by the power control unit, the inverter to not supply the power to the electric motor.

16. The apparatus of claim 15 wherein the memory stores program instructions that when executed by the controller cause the controller to carry out the operations of:
receiving from a user interface, by the power control unit, a new value for the third threshold; and
storing as the third threshold, by the power control unit, the new value.

17. The apparatus of claim 12 wherein the memory stores program instructions that when executed by the controller cause the controller to carry out the operations of:
subsequent to determining that the rotational speed of the electric motor is at or below the first threshold and the torque value is at or above the second threshold, setting, by the power control unit, a fuse parameter to indicate a torque fuse is tripped.

18. The apparatus of claim 17 wherein the memory stores program instructions that when executed by the controller cause the controller to carry out the operations of:
determining, by the power control unit, whether the fuse parameter is set to indicate the torque fuse is tripped;
in response to determining that the fuse parameter is set to indicate the torque fuse is tripped, continuing, by the power control unit, to direct the inverter to not supply the power to the electric motor; and
in response to determining that the fuse parameter is not set to indicate the torque fuse is tripped, directing, by the power control unit, the inverter to supply power to the electric motor in accordance with a subsequently received indication of throttle level.

19. The apparatus of claim 18 wherein the memory stores program instructions that when executed by the controller cause the controller to carry out the operations of:
receiving from a user interface, by the power control unit, a command indicating a user's desire to reset the fuse parameter to indicate the torque fuse is not tripped.

20. A computer program product comprising:
a set of one or more computer readable storage media; and
computer program instructions, collectively stored in the set of one or more storage media, that when executed cause a processor to perform computer operations comprising:
directing, by a power control unit, an inverter to supply power to an electric motor of an electric marine propulsion system for a watercraft;
receiving, by the power control unit, sensor data indicating a rotational speed of the electric motor;
receiving from the inverter, by the power control unit, a torque value for the electric motor;
determining, by the power control unit, whether the rotational speed of the electric motor is at or below a first threshold and the torque value is at or above a second threshold; and
in response to determining that the rotational speed of the electric motor is at or below the first threshold and the torque value is at or above the second threshold, directing, by the power control unit, the inverter to not supply the power to the electric motor.
